(19) United States
(12) Patent Application Publication
(10) Pub. No.: US 2013/0241829 A1
(43) Pub. Date: Sep. 19, 2013

(54) USER INTERFACE METHOD OF TOUCH SCREEN TERMINAL AND APPARATUS THEREFOR

(71) Applicant: SAMSUNG ELECTRONICS CO., LTD., Gyeonggi-do (KR)

(72) Inventor: Soon-Ok KIM, Seoul (KR)

(73) Assignee: SAMSUNG ELECTRONICS CO., LTD., Gyeonggi-do (KR)

(21) Appl. No.: 13/838,384

(22) Filed: Mar. 15, 2013

(30) Foreign Application Priority Data
Mar. 16, 2012 (KR) 10-2012-0027141

(51) Int. Cl. G06F 3/0354

(52) U.S. Cl. CPC G06F 3/03547
USPC 345/157

(57) ABSTRACT

A user interface method of a touch screen terminal for realizing touch commands on the screen is realized by providing at least one or more virtual touch pads, each of the virtual touch pads being displayed on the entire screen at a desired size and location and providing information and touch commands through the entire screen according to a touch event generated on each of the virtual touch pads.

### CLAIM OF PRIORITY

This application claims the benefit under 35 U.S.C. §119(a) of a Korean patent application filed in the Korean Intellectual Property Office on Mar. 16, 2012 and assigned Serial No. 10-2012-0027141, the entire disclosure of which is hereby incorporated by reference.

### BACKGROUND OF THE INVENTION

1. Field of the Invention

The present invention relates to a touch screen terminal. More particularly, the present invention relates to a user interface method implemented in a touch screen terminal for designating a position on a screen and an apparatus therefor.

2. Description of the Related Art

Portable terminals such as mobile terminals (cellular phones), electronic schedulers, and smart phones have become necessities of modern society due to a rapid development in electronic communication technology.

Manufacturers of the portable terminals are putting many efforts to enhance user's convenience in a touch screen based on a Graphic User Interface (GUI). It is clear that users have a tendency to prefer a bigger touch screen. However, a burden of touching several positions on a big screen is required more as the touch screen become bigger. For example, when the user holds a touch screen terminal with his or her one hand and touches a specific location in the touch screen with his or her thumb, there is a problem in that it is difficult for the user to touch a position which may not be reachable with the thumb in a bigger display screen.

### SUMMARY OF THE INVENTION

An aspect of the present invention is to solve at least the above-mentioned problems and/or disadvantages and to provide at least the advantages described below.

Accordingly, an aspect of the present invention is to provide a user interface method of a touch screen terminal for easily designating a position on a touch screen and an apparatus therefor.

Another aspect of the present invention is to provide a user interface method of a touch screen terminal for providing at least one or more virtual touch pads on the entire screen of a touch screen by an overlay type manner, thus controlling the contents of the touch screen according to a touch event generated on each of the virtual touch pads and an apparatus therefor.

Another aspect of the present invention is to provide a user interface method of a touch screen terminal for providing at least one or more virtual touch pads, which allow a user to control a pointer on the touch screen via the virtual touch pads and an apparatus therefor.

In accordance with an aspect of the present invention, a user interface method of a touch screen terminal includes providing at least one or more virtual touch pads, each of the virtual touch pads on the entire screen by an overlay type manner and controlling the contents of the touch screen according to a touch event generated on each of the virtual touch pads.

In accordance with another aspect of the present invention, a user interface apparatus for a touch screen terminal includes: a touch screen unit for outputting an input signal according to a touch event, and a controller for providing at least one or more virtual touch pads, each of the virtual touch pads on the entire screen of the touch screen unit by an overlay type manner and controlling the contents of the touch screen according to a touch event when the touch event is generated on each of the virtual touch pads.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating configuration of a touch screen terminal according to one embodiment of the present invention;

FIG. 2 is a flowchart illustrating a user interface process of a touch screen terminal according to one embodiment of the present invention; and

FIGS. 3 to 9 are user interface screens according to an embodiment of the present invention.

### DETAILED DESCRIPTION OF EXEMPLARY EMBODIMENTS

Exemplary embodiments of the present invention will be described herein below with reference to the accompanying drawings. For the purposes of clarity and simplicity, well-known functions or constructions are not described in detail as they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

Briefly, the present invention described hereinafter relates to a user interface method of a touch screen terminal for designating a position on a screen and an apparatus therefor. The present invention described hereinafter relates to a user interface method of a touch screen terminal for providing at least one or more virtual touch pads on the entire screen of a touch screen by an overlay type and controlling contents of the touch screen according to a touch event generated on each of the virtual touch pads and an apparatus therefor.

Particularly, the present invention described hereinafter relates to a user interface method of a touch screen terminal for providing at least one or more virtual touch pads, which allow a user to control a pointer in a touch screen and an apparatus therefor. Each of the virtual touch pads allows a user to easily place them on a touch screen because the virtual pads are smaller than the touch screen.

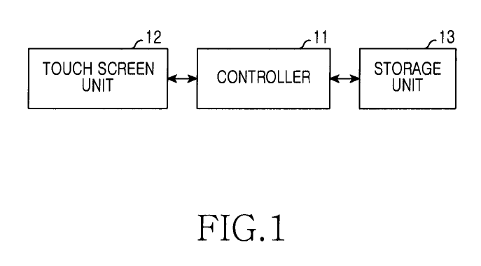

FIG. 1 is a block diagram illustrating configuration of a touch screen terminal according to one embodiment of the present invention.

Referring to FIG. 1, the touch screen terminal includes a controller 11, a touch screen unit 12, and a storage unit 13.

The touch screen unit 12 outputs an input according to a touch by a user to the controller 21 and outputs an output signal as an image under control of the controller 11.

The storage unit 13 stores certain programs for controlling an overall operation of the touch screen terminal and a variety of data items input and output when a control operation of the touch screen terminal is performed.

The controller 11 controls an overall operation of the touch screen terminal. The controller 11 performs an operation corresponding to the input signal received from the touch screen unit 12 with reference to the data items of the storage unit 13. Particularly, the controller 11 provides at least one or more virtual touch pads over the display screen where a user can control a pointer on the screen using the virtual touch pad(s). For example, the user may move the pointer and may select an icon using each of the virtual touch pads. In addition, the controller 11 allows the user to selectively set a position or size of each of the virtual touch pads.

The touch screen terminal may further include a communication unit for smoothly performing wire or wireless communication under control of the controller 11, an audio unit for processing sounds, etc.

Hereinafter, a description will be given with respect to a user interface method of a controller according to one embodiment of the present invention with reference to drawings.

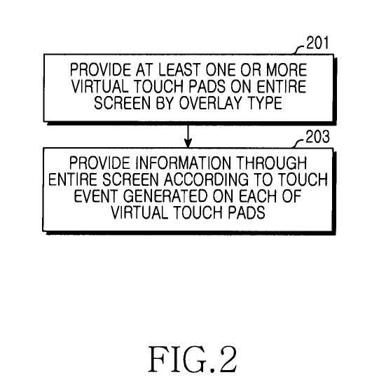

FIG. 2 is a flowchart illustrating a user interface process of a touch screen terminal according to one embodiment of the present invention.

Referring to FIGS. 1 and 2, the controller 21 provides at least one or more virtual touch pads on the entire screen of a touch screen in step 201. Then, the controller 11 allows a user to set a transparent degree of each of the virtual touch pads. In addition, the controller 11 allows the user to set the number of the virtual touch pads, or a location or size of each of the virtual touch pads.

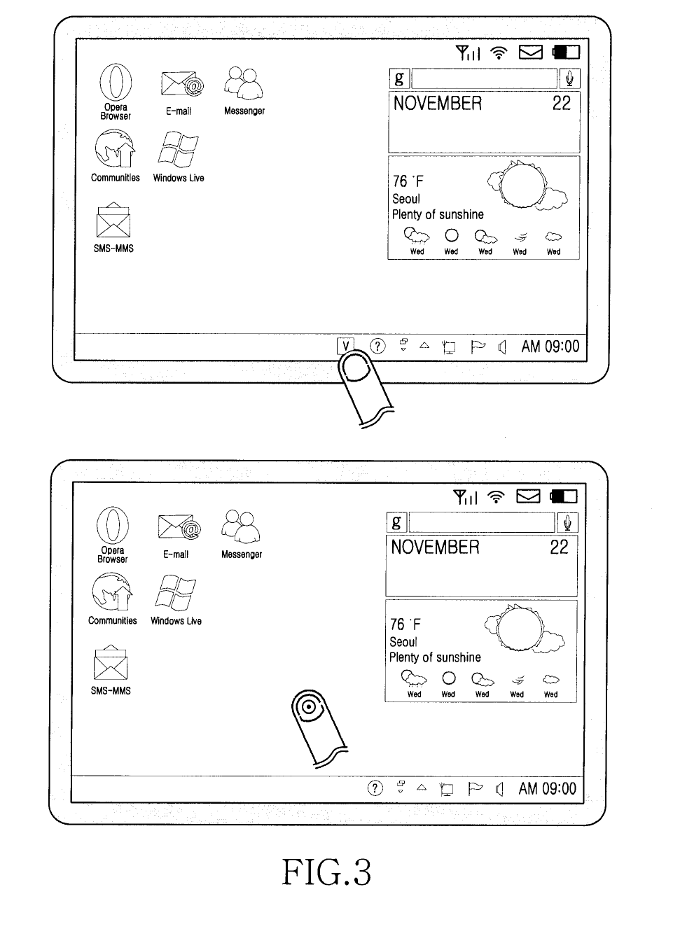

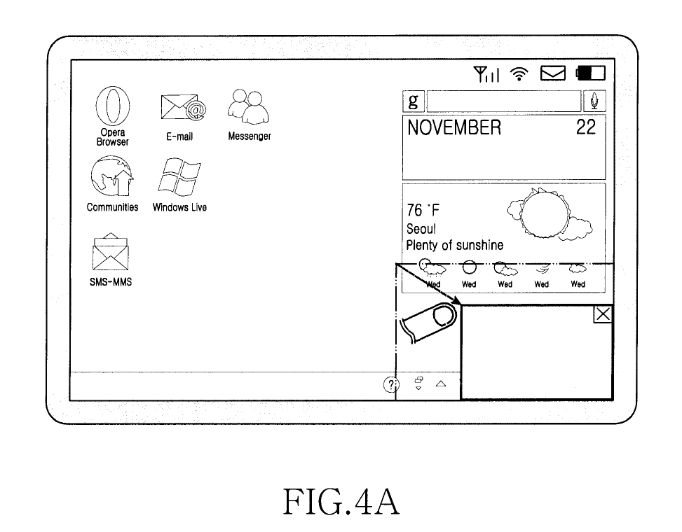

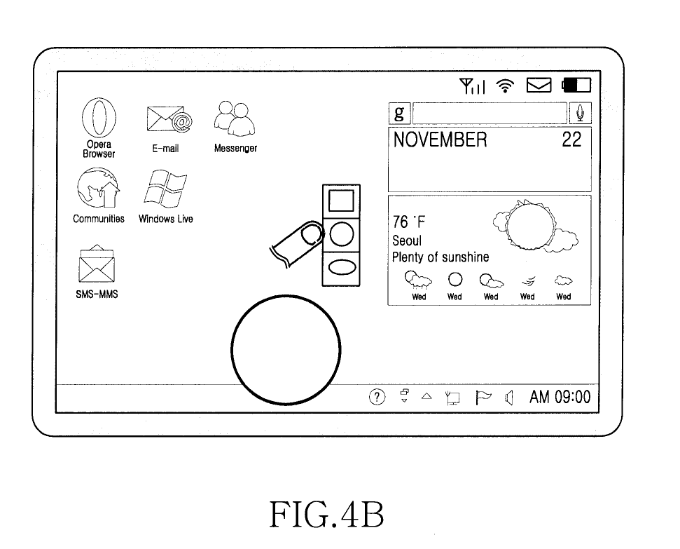

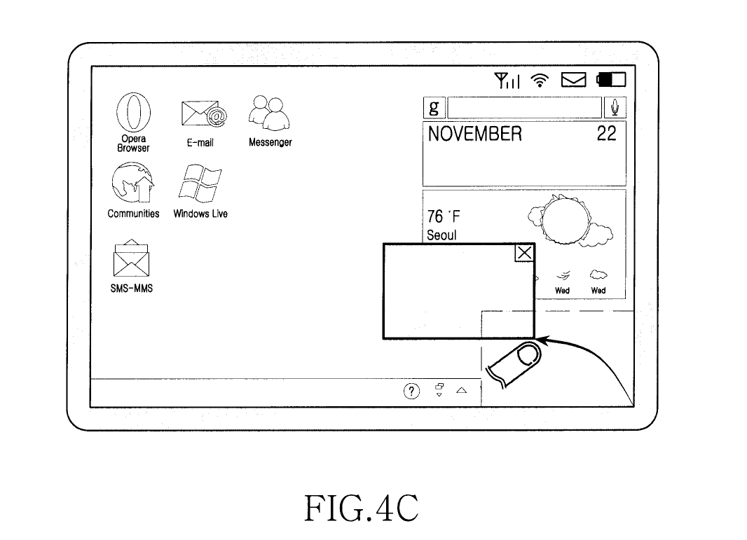

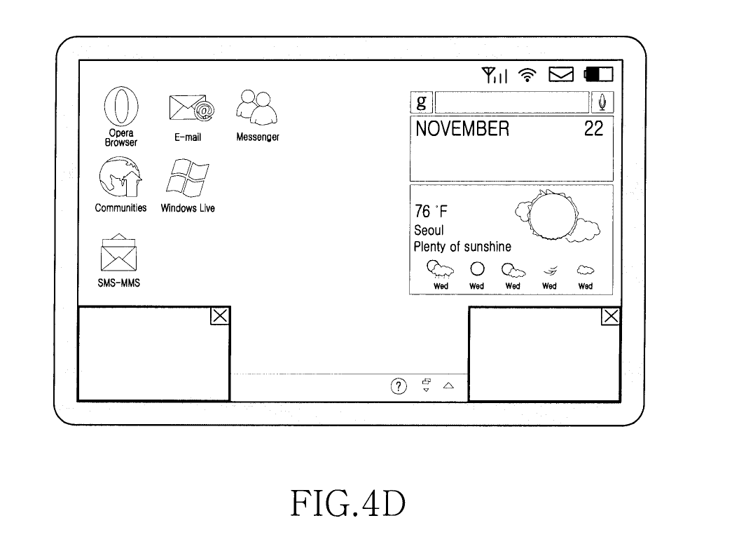

FIGS. 3 to 4D are user interface screens according to an embodiment of the present invention. More specifically, after activating a virtual pad mode, as shown in FIG. 3, FIGS. 4a-d illustrate a number of different ways to generate and position the virtual pad(s).

Referring to FIG. 3, a user pushes a previously defined button to activate a user interface according to an embodiment of the present invention, as shown in an upper screen of FIG. 3, or may activate the user interface through a touch event like a double tap event, as shown in a lower screen of FIG. 3.

Thereafter, referring to FIG. 4A, a user may place the virtual pad at a desired location by placing the finger thereto and then may change the size of the virtual touch pad. For example, when the user moves a vertex of the virtual touch pad using a touch drag event, the size of the virtual touch pad is adjusted.

In addition, referring to FIG. 4C, a user may move the virtual touch pad after generating it at a desired location.

Meanwhile, referring to FIG. 4B, a user may select a shape of the virtual touch pad. For example, the user may select the virtual touch pad of the corresponding shape on a menu of a touch screen. The menu is displayed on the entire screen in response to pushing of a preassigned button or the double tap mentioned above FIG. 3. Also, when a specific touch event is occurred on a previously displayed virtual touch pad, the previously displayed virtual touch pad is disappeared on the entire screen and the menu is displayed on the entire screen.

Also, referring to FIG. 4D, a user may activate a plurality of virtual touch pads. Although FIG. 4D depicts two square or rectangular virtual key pads shown at the bottom corner of the screen for illustrative purposes, it should be noted that placement of different shape and/or location thereof can be realized according to the teachings of the present invention. A menu is display on the entire screen in response to pushing of defined predefined button or the double tap mentioned above FIG. 3. For example, when user touches “2” button of the menu, two square virtual key pads will be displayed at the bottom corner of the screen as illustrated above FIG. 4. Also, when a specific touch event is occurred on at least one previously displayed virtual touch pad, the previously displayed virtual touch pad is disappeared on the entire screen and the menu is displayed on the entire screen.

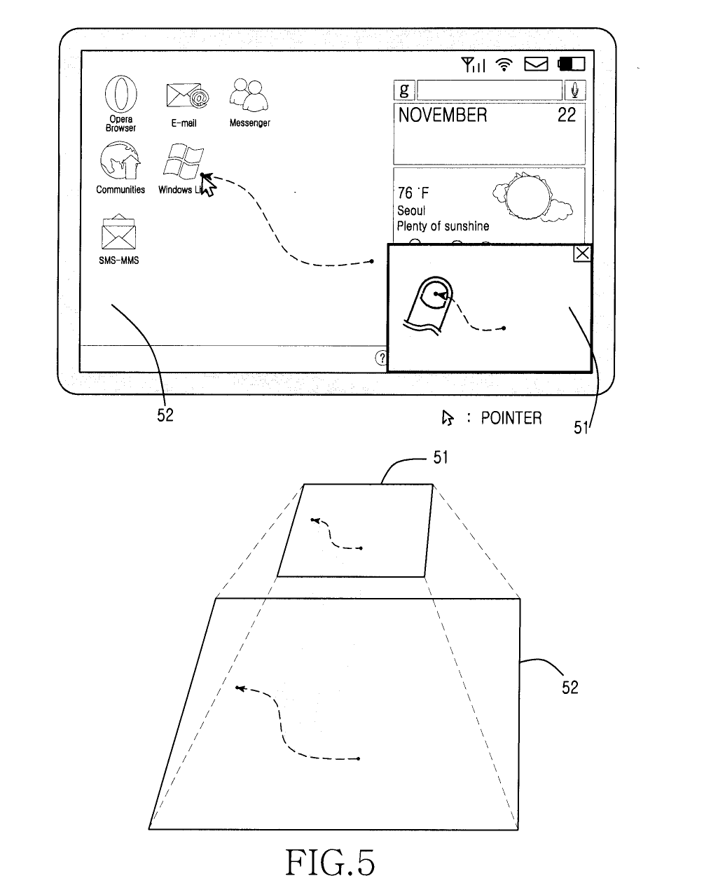

Once the virtual pad(s) are generated, the controller 11 provides information through the entire screen according to a touch event generated on each of the virtual touch pads in step 203, as explained hereinafter with reference to FIGS. 5 to 8.

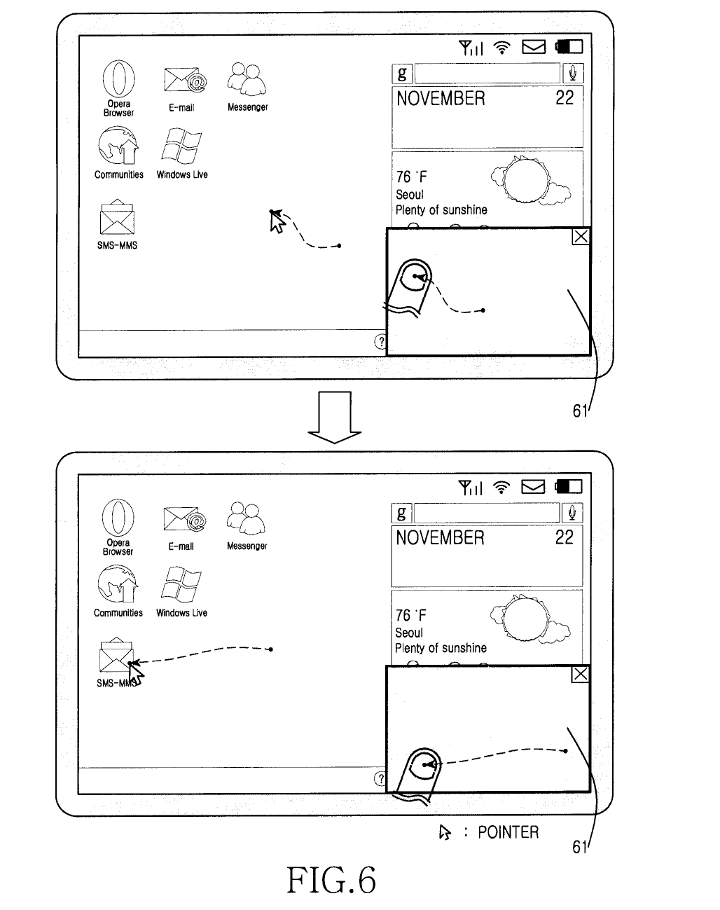

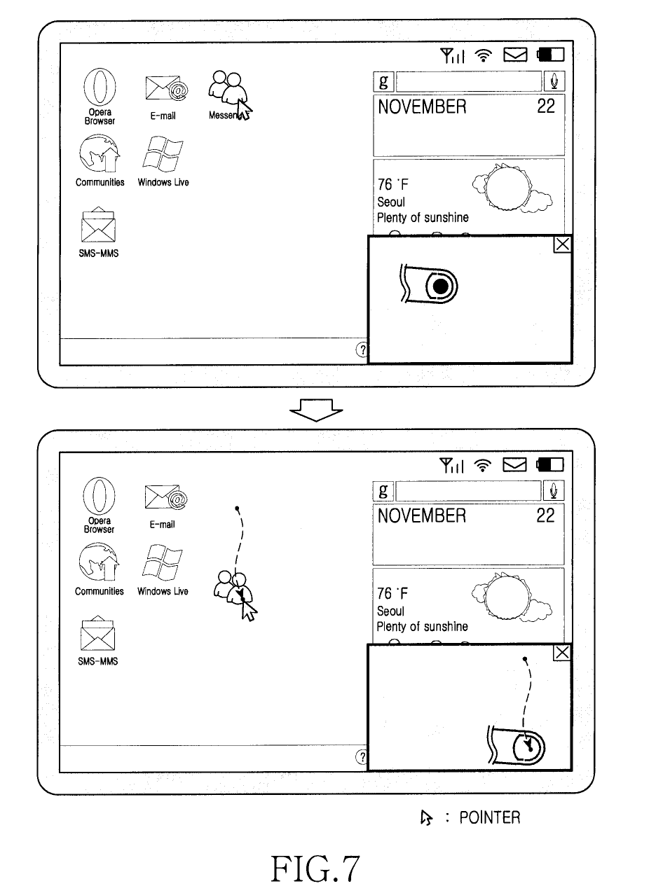

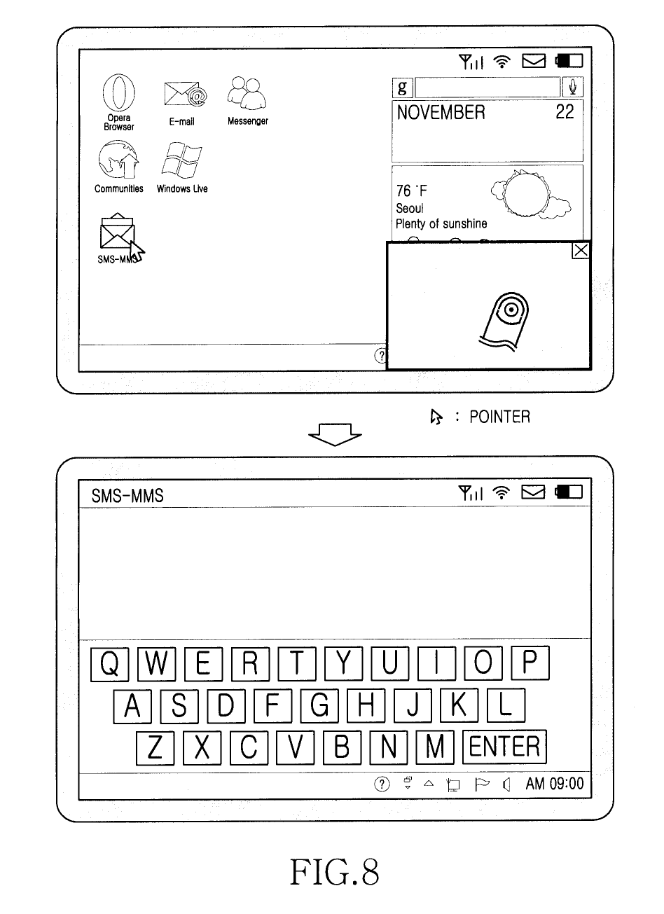

FIGS. 5 to 8 are user interface screens according to the embodiment of the present invention. In addition, although an icon to be moved or selected is displayed through the virtual touch pad, the user may move the pointer to the corresponding icon according to one embodiment of FIG. 5 or 6 and may select the corresponding icon according to one embodiment of FIG. 7 or 8.

Referring to FIGS. 1, 5, and 6, the controller 11 provides information designating a position on the entire screen, which corresponds to a touch point generated on each of virtual touch pads 51 and 61. The controller 11 provides a pointer, indicated by an arrow, designating a position on the entire screen. The controller 11 moves the pointer to correspond to a touch drag event generated on each of the virtual touch pads 51 and 61.

Referring to FIGS. 1 and 5, the virtual touch pad 51 represents a smaller screen in which the entire screen 52 is reduced at a certain ratio. Hence, the controller 11 proportionally designates a position on the entire screen 52, which corresponds to a touch point or a touch drag event generated on the virtual touch pad 51.

Referring to FIGS. 1 and 6, when a touch drag event is generated on the virtual touch pad 61, the controller 11 moves the pointer/arrow on the screen 52 according to a path of the touch drag event detected on the virtual touch pad 61.

Referring to FIGS. 1 and 7, when the pointer is positioned on an icon and a user performs a long touch on the virtual touch pad, the controller 11 determines the icon as a target to be moved which is equivalent to a click and drag action. For example, when an arrow is pointing to a message icon and a touch is detected on the virtual screen for a predetermined period, the icon is highlighted and moves according to the movement detected on the virtual pad.

Referring to FIGS. 1 and 8, when a pointer is positioned on an icon representing a text message application and a user generates a double tap event on a virtual touch pad, the controller 11 executes a program corresponding to the pointed icon.

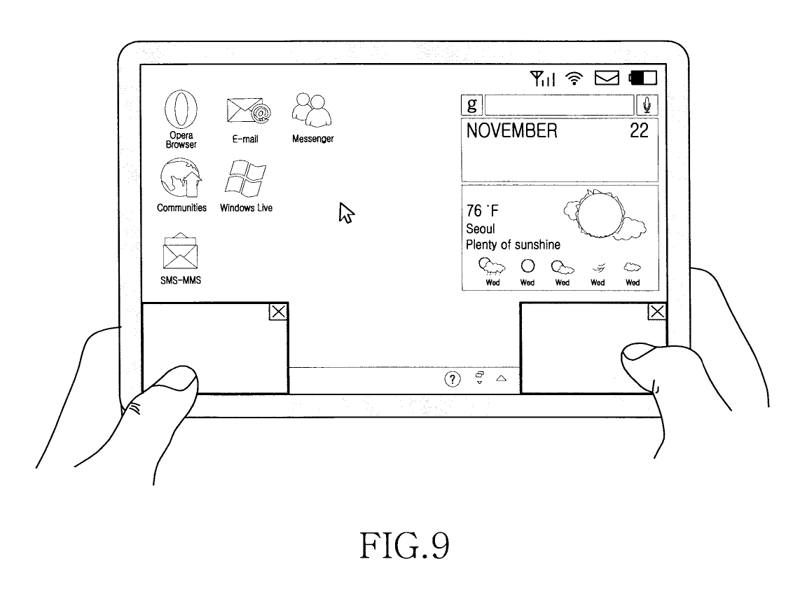

Referring to FIG. 9, when a user uses several virtual touch pads, he or she may move a pointer to a corresponding icon according to the embodiments explained above. For example, the user operates a virtual touch pad positioned on the left of a screen with his or her left finger and operates a virtual touch pad positioned on the right of the screen with his or her right finger in order to move the pointer. User may move the pointer using either the left virtual touch pad or the right virtual touch pad. Also, user may the pointer both using the left virtual touch pad and the right virtual touch. To this end, the pointer may move at corresponding position depending on a correlation of both a touch drag on the left virtual touch pad and another touch drag on the right virtual touch pad.

In addition, the controller 11 of FIG. 1 may ignore a touch event generated on a region out of the virtual touch pad. Accordingly, the controller 11 prevents an error operation from being generated on the region out of the virtual touch pad according to a touch event he or she does not want.

The controller 11 may apply all touch events which are allowed on the entire screen to the virtual touch pad. Thus, the touch events include a touch drag event, a touch flicking event, a single tap event, a double tab event, and a multi-touch event.

As is apparent from the foregoing, the present invention has an advantage in that a large touch screen can be easily controlled by a user without moving a finger across the whole region of the entire screen using at least one virtual key pad provided at a desired location by a user during operation.

Methods according to claims of the present invention and/or embodiments described in the specification of the present invention may be implemented as hardware, software, or combinational type of the hardware and the software.

When the method is implemented by the software, a computer-readable storage medium for storing one or more programs (software modules) may be provided. The one or more programs stored in the computer-readable storage medium are configured for being executed by one or more processors in an electronic device. The one or more programs include instructions for allowing an electronic device to execute the methods according to the claims of the present invention and/or the embodiments described in the specification of the present invention.

These programs (software module, software) may be stored in a Random Access Memory (RAM), a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette. Or, the programs may be stored in a memory configured by combination of some or all of them. Also, the configured memory may include a plurality of memories.

Also, the programs may be stored in an attachable storage device capable of accessing an electronic device through each of communication networks such as the Internet, an intranet, a Local Area Network (LAN), a Wide LAN (WLAN), and a Storage Area Network (SAN) or a communication network configured by combination of them. This storage device may connect to the electronic device through an external port.

Also, a separate storage device on a communication network may connect to a portable electronic device.

While the present invention has been particularly shown and described with reference to exemplary embodiments thereof, it will be understood by those skilled in the art that various changes in form and details may be made therein without departing from the spirit and scope of the present invention as defined by the appended claims

What is claimed is:

1. A user interface method in a terminal having a touch screen, comprising:
providing at least one virtual touch pad on the touch screen at a particular location; and
controlling contents on the touch screen according to a touch event generated on at least one virtual touch pad.

2. The user interface method of claim 1, wherein the provision of the at least one virtual touch pad on the touch screen comprises displaying the at least one virtual touch pad opaquely or semi-transparently.

3. The user interface method of claim 1, wherein the provision of the at least one virtual touch pad comprises adjusting a size of the at least one virtual touch pad.

4. The user interface method of claim 1, wherein the provision of the at least one virtual touch pad comprises moving the at least one virtual touch pad at a desired location.

5. The user interface method of claim 1, wherein the touch event on the at least one virtual touch pad triggers a pointer to move on the touch screen according to the touch event.

6. The user interface method of claim 1, wherein controlling the contents on the touch screen according to the touch event comprises:
providing a pointer at a particular location on the touch screen; and
providing one of an operation for moving the pointer, an operation for moving an object selected by the pointer on the touch screen, and an operation for providing a function of an icon activated by the pointer.

7. The user interface method of claim 1, wherein controlling the contents on the touch screen according to the touch event comprises providing one of an operation for changing the contents of the touch screen to previous or next contents and an operation for enlarging or reducing contents of the touch screen.

8. The user interface method of claim 1, further comprising ignoring the touch event generated on a region outside of the at least one virtual touch pad.

9. The user interface method of claim 1, wherein the touch event include one of a touch drag event, a touch flicking event, a single tab event, a double tab event, and a multi-touch event.

10. A user interface apparatus for a touch screen terminal, comprising:
a touch screen for detecting an input signal according to a touch event detected thereon; and
a controller for providing at least one virtual touch pad on the touch screen and controlling contents of the touch screen according to a touch event detected on the at least one virtual touch pad.

11. The user interface apparatus of claim 10, wherein the controller displays the at least one virtual touch pad opaquely or semi-transparently.

12. The user interface apparatus of claim 10, wherein the controller adjusts a size of the least one virtual touch pad.

13. The user interface apparatus of claim 10, wherein the controller moves the at least one virtual touch pad at a desired location.

14. The user interface apparatus of claim 10, wherein the touch event on the at least one virtual touch pad triggers a pointer to move on the touch screen according to the touch event.

15. The user interface apparatus of claim 10, wherein the controller provides a pointer at a particular location on the touch screen and performs one of an operation for moving the pointer, an operation for moving an object selected by the pointer on the touch screen and an operation for providing a function of an icon activated by the pointer.

16. The user interface apparatus of claim 10, wherein the controller performs one of an operation for changing the contents of the touch screen to previous or next contents and an operation for enlarging or reducing the contents of the touch screen according to the touch event.

17. The user interface apparatus of claim 10, wherein the controller ignores the touch event generated on a region outside the least one virtual touch pad.

18. The user interface apparatus of claim 10, wherein the touch event include one of a touch drag event, a touch flicking event, a single tab event, a double tab event, and a multi-touch event.
